(19) United States
(12) Patent Application Publication
(10) Pub. No.: US 2026/0270368 A1
(43) Pub. Date: Sep. 10, 2026

(54) SYSTEM

(71) Applicant: SOFTBANK GROUP CORP., Tokyo (JP)

(72) Inventor: Shinichi KAWASHIMA, Tokyo (JP)

(73) Assignee: SOFTBANK GROUP CORP., Tokyo (JP)

(21) Appl. No.: 19/557,230

(22) Filed: Mar. 5, 2026

Related U.S. Application Data
(60) Provisional application No. 63/767,947, filed on Mar. 6, 2025.

(51) Int. Cl. H04N 7/15; G06V 40/16; G10L 15/26

(52) U.S. Cl. CPC H04N 7/15; G06V 40/168; G10L 15/26

(57) ABSTRACT

A system where AI automatically performs facilitation during video conferences is provided. An image acquisition unit and an audio acquisition unit acquire participants' image and audio data in real time. An expression analysis unit and an audio analysis unit analyze this data to quantify emotions. An emotion integration evaluation unit integrates the analyzed emotion data and evaluates the overall emotional state of the meeting. The facilitation control unit determines actions to optimize meeting progress based on the evaluation results and provides real-time feedback. This reduces participant burden and enhances meeting quality and effectiveness. Particularly in remote work environments, it enables smooth non-face-to-face communication. For meetings in specific specialized fields, it can select appropriate facilitation methods by referencing pre-set templates or past data.

### CROSS-REFERENCE TO RELATED APPLICATION

This application claims priority under 35 U.S.C. § 119 to U.S. Provisional Patent Application No. 63/767,947, filed on March 6, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

The system and method for improving the quality of communication among participants in video conferences, which have increased with the spread of remote work is provided. Specifically, in non-face-to-face meetings, there is a need to accurately grasp participants' emotions from their spoken content, facial expressions, and tone of voice, and to optimize the progress of the meeting. Conventional video conferencing tools often struggle to grasp participants' emotional states in real time, frequently leading to one-sided meeting progression or stagnant discussions. This resulted in reduced meeting quality and increased participant burden.

Furthermore, meetings in specific specialized fields require specialized facilitation, which was difficult to automate with conventional systems. The disclosure shows ways to solve these challenges by utilizing AI to quantify participants' emotions and adjust meeting progress in real time.

This enables the reduction of participant burden and enhances meeting quality and effectiveness. Furthermore, by providing specialized facilitation tailored to specific areas like patents or strategy, it creates an environment conducive to smoother, more advanced discussions.

The means by which this invention solves the challenges is to provide a system comprising a video acquisition unit, an audio acquisition unit, an expression analysis unit, an audio analysis unit, an emotion integration evaluation unit, and a facilitation control unit. Specifically, the video acquisition unit acquires video data of participants in real time during a video conference, and the audio acquisition unit acquires audio data of participants. Next, the facial expression analysis unit detects facial feature points from the acquired video data and analyzes subtle changes in facial expressions to quantify participants' emotions. The speech analysis unit analyzes the audio data, converts spoken content into text, and analyzes voice tone, pitch, and speed to quantify emotions.

This quantified emotional data is integrated by the emotion integration evaluation unit to assess the overall emotional state of the meeting. Based on this assessment, the facilitation control unit determines actions to optimize the meeting's progress. For example, if many participants show dissatisfaction, it may propose changing the agenda or adjusting the direction of discussion. Furthermore, for meetings in specific specialized fields, it can select an appropriate facilitation method by referencing pre-set templates or historical data.

In this way, AI automatically optimizes meeting progress, reducing participant burden while enhancing meeting quality and effectiveness. This enables smooth non-face-to-face communication even in remote work environments.

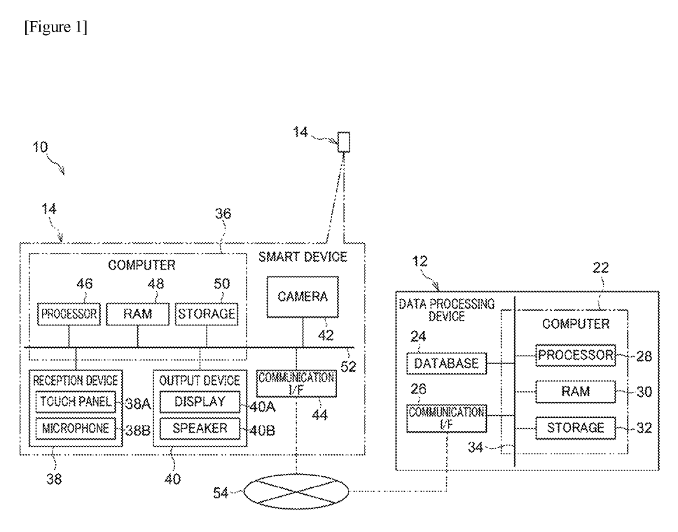

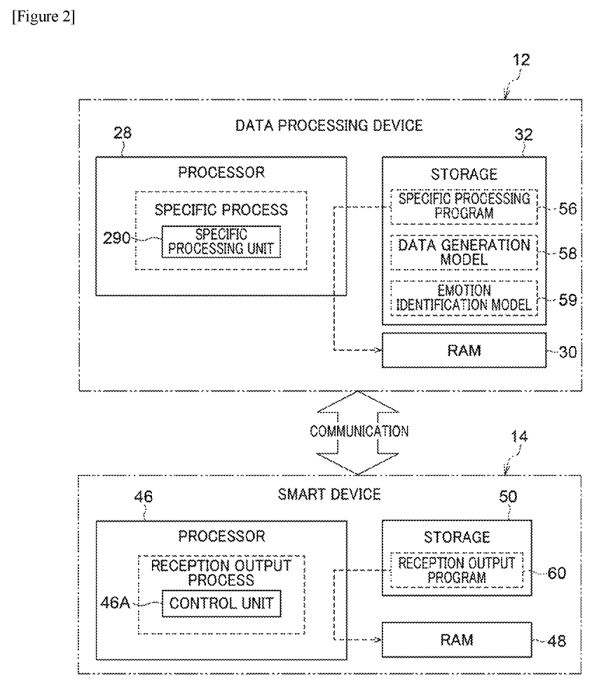

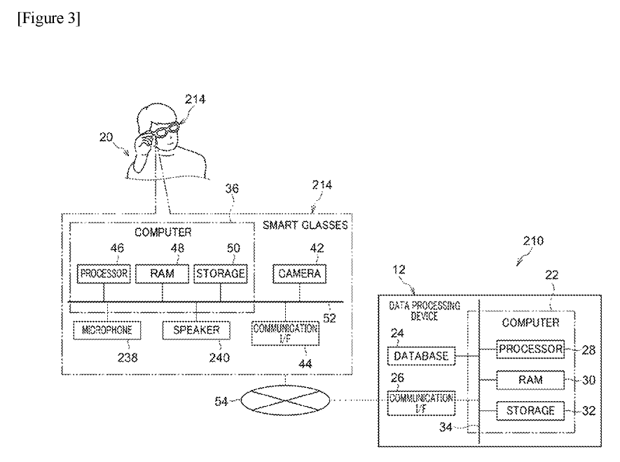

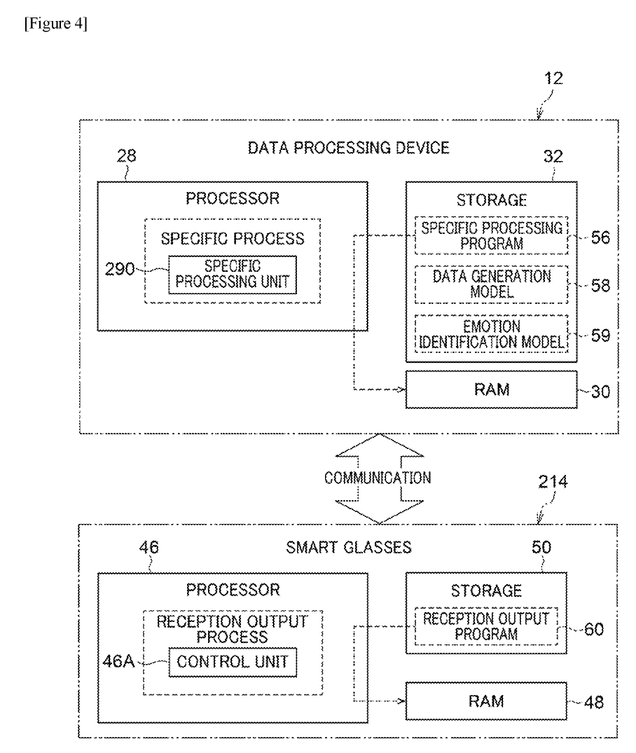

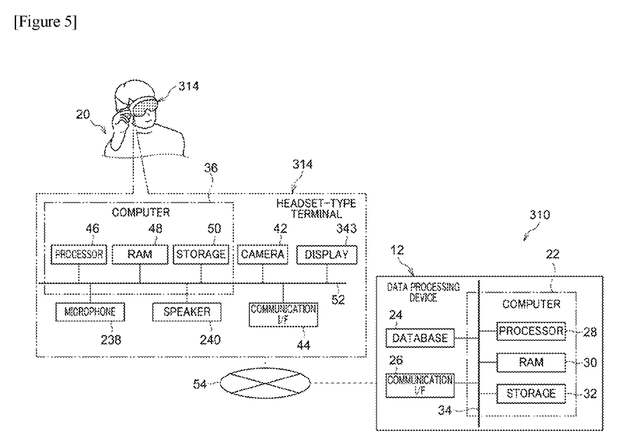

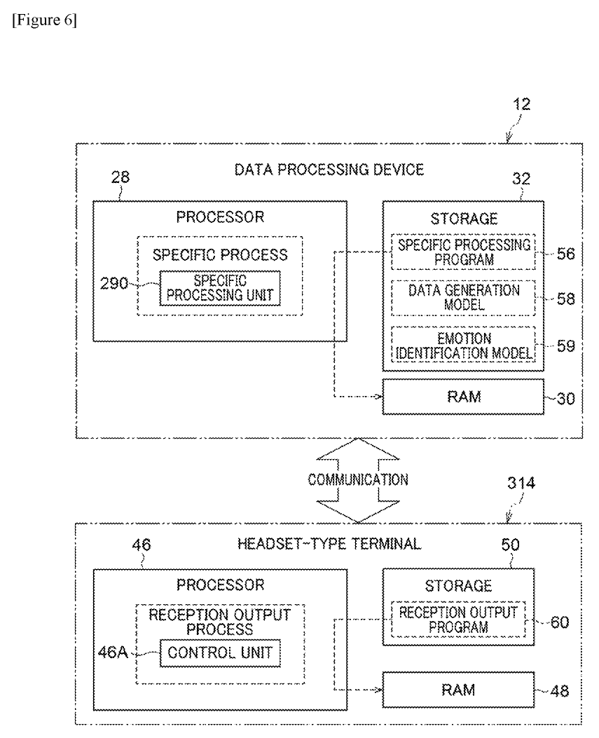

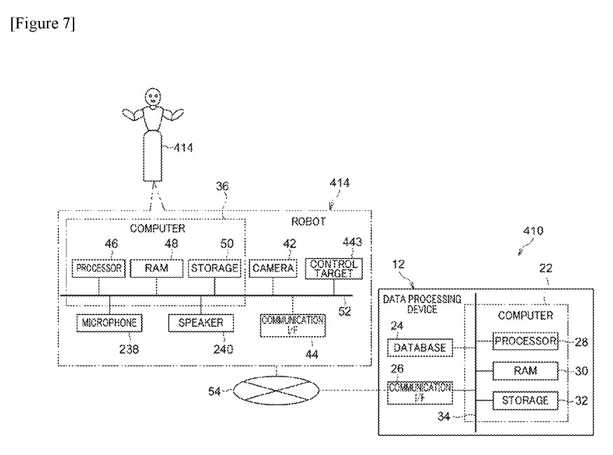

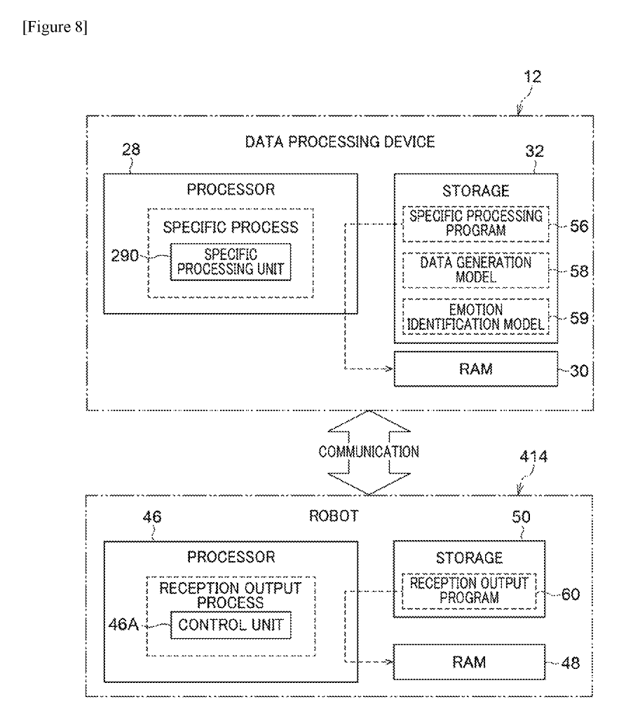

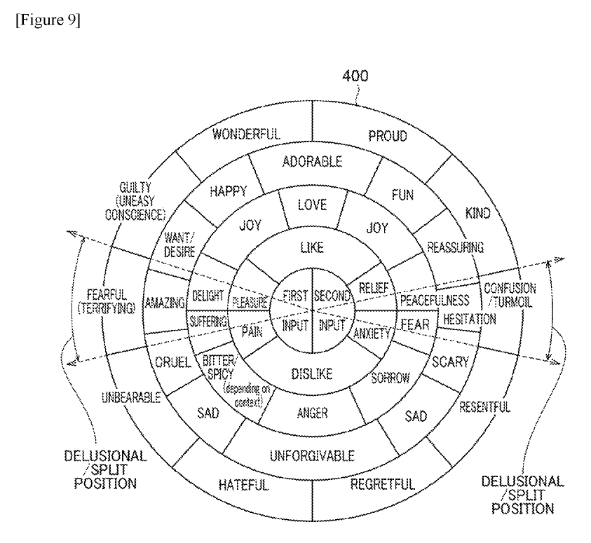

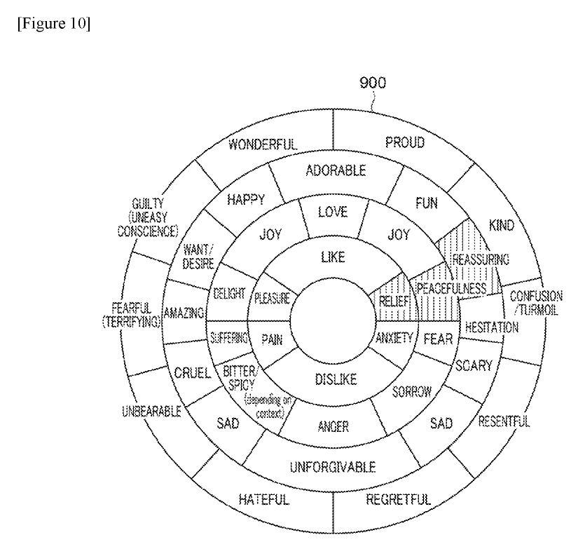

### BRIEF DESCRIPTION OF THE DRAWING

[FIG. 1] is a conceptual diagram showing an example configuration of the data processing system according to the first embodiment.

[FIG. 2] is a conceptual diagram showing an example of key functions of the data processing device and smart device according to the first embodiment.

[FIG. 3] is a conceptual diagram showing an example configuration of the data processing system according to the second embodiment.

[FIG. 4] is a conceptual diagram showing an example of the main functions of the data processing device and smart glasses according to the second embodiment.

[FIG. 5] is a conceptual diagram showing an example configuration of a data processing system according to a third embodiment.

[FIG. 6] is a conceptual diagram showing an example of the main functions of the data processing device and headset-type terminal according to the third embodiment.

[FIG. 7] is a conceptual diagram showing an example configuration of a data processing system according to the fourth embodiment.

[FIG. 8] is a conceptual diagram showing an example of the main functions of the data processing device and robot according to the fourth embodiment.

[FIG. 9] shows an emotion map onto which multiple emotions are mapped.

[FIG. 10] shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor(hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM(Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the communication I/F(Interface) is an interface that includes a communication processor and an antenna, among other components. The communication I/F governs communication between multiple computers. Examples of communication standards applicable to the communication I/F include wireless communication standards such as 5G (5^{th} Generation Mobile Communication System), Wi-Fi (registered trademark), or Bluetooth (registered trademark).

In the following embodiments, "A and/or B" is synonymous with "at least one of A and B." That is, "A and/or B" may mean A alone, B alone, or a combination of A and B. Furthermore, in this specification, when three or more items are connected using "and/or," the same concept applies as for "A and/or B".

### First Embodiment

FIG. 1 shows an example configuration of the data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing unit 12. Within the data processing unit 12, the specific processing unit 290 acquires the data indicating the user input.

Output device 40 includes display 40A and speaker 40B, among others, presenting data to user 20 by outputting it in a perceptible form (e.g., audio and/or text). Display 40A displays visual information such as text and images according to instructions from processor 46. Speaker 40B outputs audio according to instructions from processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis(parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

The embodiment for implementing the present invention is described in further detail below. This system is realized using a server and a terminal, clarifying how the functions are distributed among the components.

First, the terminal is the device used by participants and is equipped with a camera and microphone. The terminal is responsible for acquiring participants' video and audio data in real time during the video conference. The video acquisition unit captures the participant's face through the terminal's camera and generates video data. For example, the built-in camera of a notebook computer or an external webcam can be used. The audio acquisition unit records the participant's speech through the terminal's microphone and generates audio data. This can utilize the built-in microphone of a notebook computer or a headset microphone.

Next, the server plays a central role in processing the video and audio data transmitted from the terminal. The facial expression analysis unit is implemented on the server and receives the video data transmitted from the terminal. The server uses advanced facial recognition technology to detect facial feature points. For example, it analyzes details such as eye position, mouth shape, and eyebrow movement to capture subtle changes in facial expressions. This enables the quantification of participants' emotions and the identification of emotions such as joy, anger, sadness, and surprise.

The audio analysis unit is also implemented on the server and receives audio data transmitted from the terminal. The server uses speech recognition technology to convert spoken content into text. Furthermore, it analyzes voice tone, pitch, and speed to infer the speaker's emotional state. For example, it can detect excitement by analyzing variations in voice pitch or infer nervousness from changes in speaking speed.

The Emotion Integration Evaluation Unit integrates the emotion data obtained from the Facial Expression Analysis Unit and the Speech Analysis Unit to evaluate the overall emotional state of the meeting. The server aggregates emotional data from each participant and monitors the meeting's progress in real time. Based on this evaluation, the facilitation control unit, implemented on the server, determines actions to optimize the meeting's flow. For instance, if many participants show dissatisfaction, it may propose changing the agenda or adjusting the direction of discussion. Furthermore, for meetings in specific specialized fields, it can select appropriate facilitation methods by referencing pre-set templates or historical data.

Furthermore, the server provides real-time feedback and sends instructions to participants' terminals. For instance, if speaking is skewed, it can issue instructions encouraging other participants to speak. This smooths the meeting flow and provides an environment where all participants can actively engage. The server monitors participants' speaking frequency and duration and can issue alerts to adjust speaking balance as needed.

In this way, the server and terminals collaborate, enabling AI to automatically optimize meeting progress. This reduces participant burden while enhancing meeting quality and effectiveness. Consequently, even in remote work environments, smooth non-face-to-face communication can be achieved. Furthermore, the server implements security measures, such as data encryption and access control, to protect participant privacy and provide a secure meeting environment.

### System Configuration

The system according to this embodiment comprises a video acquisition unit, an audio acquisition unit, an expression analysis unit, an audio analysis unit, an emotion integration evaluation unit, and a facilitation control unit. The video acquisition unit is responsible for acquiring participant video data in real-time during a video conference. Specifically, it captures participants' faces using cameras built into laptops, tablets, or smartphones. This enables detailed capture of participants' expressions during the meeting. For example, it can accurately capture moments when a participant smiles or frowns. Furthermore, using an external high-resolution camera allows acquisition of even clearer video data.

The audio acquisition unit records participants' speech in real time and generates audio data. While built-in microphones in laptops or smartphones are typically used, employing a headset microphone with noise-canceling functionality is also recommended to obtain clear audio. This enables the clear recording of speech content during meetings, aiding subsequent analysis. For instance, it allows high-quality capture of audio when a participant makes an important proposal.

The facial expression analysis unit receives video data transmitted from the video acquisition unit and detects facial feature points using facial recognition technology. This enables the analysis of subtle changes in participants' facial expressions and the quantification of their emotions. For example, by analyzing details such as eye movements, the degree of mouth corner elevation, and eyebrow movements, it can identify whether a participant is happy, angry, or surprised. Additionally, the direction of the face and eye movements are analyzed, enabling the evaluation of the participant's attention focus and concentration level.

The voice analysis unit receives voice data transmitted from the voice acquisition unit and converts the spoken content into text using voice recognition technology. Furthermore, it analyzes voice tone, pitch, and speed to infer the speaker's emotional state. For example, it can detect excitement by analyzing variations in voice pitch or infer nervousness from changes in speaking speed. Additionally, by identifying emphasized parts of speech, it can understand which parts the speaker considers important.

The Emotion Integration Evaluation Unit integrates emotion data obtained from the Facial Expression Analysis Unit and the Voice Analysis Unit to evaluate the overall emotional state of the meeting. It aggregates emotion data from each participant to monitor the meeting's progress in real time. For example, if many participants show dissatisfaction, it can be determined that the meeting's progress needs to be reviewed. Furthermore, by tracking emotional changes over time, it is possible to identify which parts of the meeting were stressful for participants.

The Facilitation Control Unit determines actions to optimize meeting progress based on the Emotion Integration Evaluation Unit's assessment. For instance, if many participants show dissatisfaction, it may propose changing the agenda or adjusting the direction of discussion. Furthermore, for meetings in specific specialized fields, it can select appropriate facilitation methods by referencing pre-set templates or historical data. Furthermore, it provides real-time feedback and sends instructions to participants' terminals. For instance, if discussion is dominated by certain speakers, it can issue instructions encouraging other participants to speak.

Specific examples of prompt sentences to be fed into the generative AI required to implement the present invention include: "Analyze participants' facial expressions and voices during meetings, quantify emotions, and suggest methods to optimize meeting progress," or "Propose an algorithm to integrate participant emotion data and adjust meeting progress in real time." This establishes a foundation for the AI to perform appropriate analysis and control.

### Implementation Steps

Step 1: Acquire Video Data

When a video conference begins, video data of participants is acquired in real time using the terminal's camera. The camera built into a laptop, tablet, or smartphone is used to capture the participant's face. This allows for detailed capture of the participant's facial expressions during the meeting. For example, it is possible to accurately capture the moment a participant smiles or frowns. Using an external high-resolution camera also enables acquisition of clearer video data.

Step 2: Audio Data Acquisition

Record participants' speech in real time using the device's microphone to generate audio data. While built-in microphones in laptops or smartphones are commonly used, employing a headset microphone with noise-canceling functionality is also recommended to obtain clear audio. This enables the clear recording of spoken content during meetings, aiding subsequent analysis.

Step 3: Facial Expression Analysis

The facial expression analysis unit on the server receives video data transmitted from the video acquisition unit and detects facial feature points using face recognition technology. This enables the analysis of subtle changes in participants' facial expressions and the quantification of emotions. For example, by analyzing details such as eye movements, the degree of mouth corner elevation, and eyebrow movements, it can identify whether a participant is happy, angry, or surprised.

Step 4: Voice Analysis

The server's speech analysis unit receives speech data transmitted from the speech acquisition unit and converts the spoken content into text using speech recognition technology. Furthermore, it analyzes voice tone, pitch, and speed to infer the speaker's emotional state. For example, it can detect excitement by analyzing variations in voice pitch or infer nervousness from changes in speaking speed.

Step 5: Emotion Integration and Evaluation

The emotion integration and evaluation unit integrate the emotion data obtained from the facial expression analysis unit and the speech analysis unit to evaluate the overall emotional state of the meeting. It aggregates the emotion data of each participant and monitors the progress of the meeting in real time. For example, if many participants show dissatisfaction, it can be determined that the meeting's progress needs to be reviewed.

Step 6: Facilitation Control

The Facilitation Control Unit determines actions to optimize meeting progress based on the Emotion Integration Evaluation Unit's assessment. For instance, if many participants show dissatisfaction, it may propose changing the agenda or adjusting the direction of discussion. Additionally, for meetings in specific specialized fields, it can select appropriate facilitation methods by referencing pre-set templates or historical data.

Step 7: Utilizing Generative AI

Generative AI is used to develop algorithms for optimizing meeting progression. Specific examples of prompts fed to the generative AI include: "Analyze participants' facial expressions and audio during meetings, quantify emotions, and suggest methods to optimize meeting progression," or "Propose an algorithm to integrate participant emotion data and adjust meeting progression in real-time." This establishes the foundation for the AI to perform appropriate analysis and control.

Step 8: Real-Time Feedback

The server provides real-time feedback and sends instructions to participants' devices. For example, if speaking is skewed toward certain individuals, it can issue instructions encouraging other participants to speak. This smooths the meeting flow and provides an environment where all participants can actively engage. The server can also monitor participants' speaking frequency and duration, issuing alerts to adjust speaking balance as needed.

### Specific Use Cases

For example, consider an international project team conducting a remote video conference. This team consists of members located in multiple countries across different time zones, requiring efficient meeting progression. The system acquires video and audio data in real time from each member's device and transmits it to the server. The video acquisition unit captures participants' faces in detail, and the facial expression analysis unit analyzes this data to quantify emotions. For example, it identifies whether a participant is smiling or maintaining a serious expression during a presentation, thereby gauging the meeting atmosphere.

The audio acquisition unit records spoken content, which the audio analysis unit converts into text. It further analyzes voice tone and pitch to infer the speaker's emotional state. For example, it can determine whether a speaker is speaking confidently or nervously. The emotion integration evaluation unit combines this data to assess the overall emotional state of the meeting. For instance, if many participants show dissatisfaction, the facilitation control unit suggests changing the agenda.

The facilitation control unit determines actions to optimize meeting progress and provides real-time feedback. For example, if a specific participant speaks frequently, it can issue instructions encouraging other participants to speak. This smooths the meeting flow and provides an environment where everyone can actively participate.

In the step utilizing generative AI, prompts such as "Analyze participants' facial expressions and audio during meetings, quantify emotions, and suggest methods to optimize meeting progress" or "Integrate participant emotion data and propose algorithms to adjust meeting progress in real time" are used. This establishes the foundation for the AI to perform appropriate analysis and control.

In this way, the system enables the reduction of participant burden and the enhancement of meeting quality and effectiveness during video conferences for international project teams. This facilitates smooth non-face-to-face communication even in remote work environments.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

A further specific and detailed description of an embodiment for implementing the present invention is provided. This embodiment is a system that supports communication between residents and staff within a nursing care facility and provides appropriate care by grasping the emotional state of residents in real time.

First, multiple cameras and microphones are installed within the facility, positioned in each room and common areas. The image acquisition unit uses these cameras to capture real-time video data of residents. For example, it can capture detailed expressions of a resident watching TV in the living room or while eating in the dining area. This enables accurate observation of the resident's facial expressions. Furthermore, the high-resolution cameras capture even subtle changes in expression, allowing for more precise assessment of the resident's emotional state.

Next, the audio acquisition unit records residents' speech using microphones installed within the facility. This enables detailed recording of the tone of voice used by residents, including pitch and speaking speed. For example, it can determine the tone of voice a resident uses when conversing with staff or the pitch of their voice when chatting with other residents. The microphones feature noise-canceling capabilities, allowing for clear audio acquisition by eliminating background noise.

The facial expression analysis unit receives video data transmitted from the video acquisition unit and uses facial recognition technology to detect facial feature points. This enables analysis of subtle changes in the resident's facial expressions and quantifies their emotions. For example, by analyzing details such as eye movements, the degree of upward movement of the corners of the mouth, and eyebrow movements, it can identify whether the resident is happy, angry, or surprised. Additionally, the analysis includes facial orientation and gaze movement, enabling evaluation of the resident's attention focus and concentration level. This allows understanding of the activities that interest the resident.

The voice analysis unit receives voice data transmitted from the voice acquisition unit and converts the spoken content into text using voice recognition technology. Furthermore, it analyzes voice tone, pitch, and speed to infer the speaker's emotional state. For example, it can detect excitement by analyzing pitch variations or infer tension from changes in speaking speed. By identifying emphasized parts of speech, it can understand which sections the speaker considers important. This enables more accurate understanding of the resident's needs and requests.

The Emotion Integration Evaluation Unit integrates emotion data obtained from the Facial Expression Analysis Unit and the Voice Analysis Unit to evaluate the resident's emotional state. This enables real-time understanding of the resident's emotional state. For example, if a resident feels anxious, the system detects this state and prompts appropriate action. Furthermore, by tracking emotional changes over time, the system can quickly detect shifts in the resident's emotional state and prompt immediate action from care staff. This enables rapid response to changes in the resident's emotions.

The Facilitation Control Unit proposes appropriate care methods to care staff based on the evaluation results from the Emotion Integration Evaluation Unit. For example, if a resident is feeling anxious, it can instruct staff to engage in verbal communication or provide a relaxing environment. Furthermore, if a resident is calm, it can propose care methods to maintain that state. Furthermore, it can propose specific countermeasures to staff based on the resident's emotional state, thereby improving the resident's quality of life. This enhances the quality of care provided to residents and reduces the burden on staff.

In this way, the system supports communication between residents and staff within the care facility. By understanding residents' emotional states in real time, it enables the provision of appropriate care. This improves residents' quality of life and reduces the burden on care staff. Furthermore, the system implements security measures, such as data encryption and access control, to protect residents' privacy and provide a safe environment.

### System Configuration

The system according to this embodiment comprises an image acquisition unit, an audio acquisition unit, an expression analysis unit, an audio analysis unit, an emotion integration evaluation unit, and a facilitation control unit. The image acquisition unit acquires real-time image data of residents using multiple cameras installed within the care facility. This enables detailed observation of the residents' facial expressions. For example, it can capture relaxed expressions while residents watch TV in the living room or satisfied expressions while eating in the dining area. Furthermore, the high-resolution cameras can detect subtle changes in facial expressions, allowing for more accurate understanding of the residents' emotions.

The audio acquisition unit uses microphones installed within the facility to record residents' speech in real time. This allows detailed recording of the tone of voice used by residents, including pitch and speed. For example, it can determine the gentle tone of voice when a resident is conversing with staff or the cheerful pitch when chatting with other residents. The microphones feature noise-canceling capabilities, enabling clear audio acquisition by eliminating background noise.

The facial expression analysis unit receives video data transmitted from the video acquisition unit and uses facial recognition technology to detect facial feature points. This enables analysis of subtle changes in the resident's facial expressions and quantifies their emotions. For example, by analyzing details such as eye movements, the degree of upward movement of the corners of the mouth, and eyebrow movements, it can identify whether the resident is happy, angry, or surprised. Additionally, the analysis includes facial orientation and gaze movement, enabling evaluation of the resident's attention focus and concentration level. This allows understanding of the activities that interest the resident.

The voice analysis unit receives voice data transmitted from the voice acquisition unit and converts the spoken content into text using voice recognition technology. Furthermore, it analyzes voice tone, pitch, and speed to infer the speaker's emotional state. For example, it can detect excitement by analyzing pitch variations or infer tension from changes in speaking speed. By identifying emphasized parts of speech, it can understand which sections the speaker considers important. This enables more accurate understanding of the resident's needs and requests.

The Emotion Integration Evaluation Unit integrates emotion data obtained from the Facial Expression Analysis Unit and the Voice Analysis Unit to evaluate the resident's emotional state. This enables real-time understanding of the resident's emotional state. For example, if a resident feels anxious, the system detects this state and prompts appropriate action. Furthermore, by tracking emotional changes over time, the system can quickly detect shifts in the resident's emotional state and prompt immediate action from care staff. This enables rapid response to changes in the resident's emotions.

The Facilitation Control Unit proposes appropriate care methods to care staff based on the evaluation results from the Emotion Integration Evaluation Unit. For example, if a resident is feeling anxious, it can instruct staff to engage in verbal communication or provide a relaxing environment. Furthermore, if a resident is calm, it can propose care methods to maintain that state. Furthermore, it can propose specific countermeasures to staff based on the resident's emotional state, thereby improving the resident's quality of life. This enhances the quality of care provided to residents and reduces the burden on staff.

Specific examples of prompt sentences to feed into the generative AI required to implement the present invention include: "Please teach me how to analyze residents' facial expressions and voices within a care facility, quantify their emotions, and propose appropriate care methods," or "Please propose an algorithm to integrate residents' emotional data and adjust care progress in real-time." This enables the establishment of a foundation for the AI to perform appropriate analysis and control.

### Implementation Steps

Step 1: Acquire Video Data

Acquire real-time video data of residents using cameras installed within the care facility. Cameras are positioned in each room and common areas, enabling detailed capture of residents' facial expressions. For example, they can capture relaxed expressions while residents watch TV in the living room or satisfied expressions while eating in the dining area. The high-resolution cameras can detect subtle changes in facial expressions, allowing for more accurate assessment of residents' emotions.

Step 2: Audio Data Acquisition

Using microphones installed throughout the facility, the system records residents' speech in real time. This allows detailed recording of the tone of their speech, including pitch and speed. For example, it can determine the calm tone of a resident's voice when conversing with staff or the cheerful pitch when chatting with other residents. The microphones feature noise-canceling capabilities, enabling clear audio capture by eliminating background noise.

Step 3: Facial Expression Analysis

Receive video data transmitted from the video acquisition unit and detect facial feature points using face recognition technology. This enables analysis of subtle changes in the resident's facial expressions and quantifies their emotions. For example, detailed analysis of eye movements, the degree of upward curvature of the mouth corners, and eyebrow movements allows identification of whether the resident is happy, angry, or surprised. Additionally, facial orientation and gaze movement are analyzed, enabling evaluation of the resident's attention focus and concentration level.

Step 4: Audio Analysis

Receives audio data transmitted from the audio acquisition unit and converts the spoken content into text using speech recognition technology. Furthermore, analyzes voice tone, pitch, and speed to infer the speaker's emotional state. For example, it can detect excitement by analyzing variations in voice pitch or infer tension from changes in speaking speed. Additionally, by identifying emphasized parts of the speech, it is possible to understand which parts the speaker considers important.

Step 5: Emotion Integration and Evaluation

The emotion data obtained from the facial expression analysis unit and the voice analysis unit is integrated to evaluate the resident's emotional state. This enables real-time understanding of the resident's emotional state. For example, if a resident feels anxious, the system detects this state and prompts an appropriate response. Furthermore, by tracking emotional changes over time, changes in the resident's emotional state can be detected quickly, prompting immediate action from care staff.

Step 6: Facilitation Control

Based on the evaluation results from the Emotion Integration Evaluation Unit, it proposes appropriate care methods to the care staff. For example, if a resident is feeling anxious, it can instruct staff to offer verbal reassurance or provide a relaxing environment. Furthermore, if a resident is calm, it can propose care methods to maintain that state. Moreover, depending on the resident's emotional state, it can suggest specific countermeasures to the staff, thereby improving the resident's quality of life.

Step 7: Utilizing Generative AI

Develop an algorithm using generative AI to analyze resident emotional data and propose appropriate care methods. Examples of prompt sentences fed to the generative AI include: "Please teach me how to analyze residents' facial expressions and voices within a care facility, quantify their emotions, and propose appropriate care methods," or "Please propose an algorithm to integrate resident emotional data and adjust care progress in real-time." This establishes the foundation for the AI to perform appropriate analysis and control.

### Specific Use Cases

For example, consider a situation in a care facility where one resident routinely spends a significant amount of time in the living room. This resident's daily routine includes watching television and enjoying conversations with other residents. The system uses cameras and microphones installed in the living room to capture the resident's video and audio in real time. The image acquisition unit captures the resident's facial expressions in detail, and the expression analysis unit analyzes these to quantify emotions. For example, if the resident smiles while watching TV, the system can quantify that emotion as "joy."

The audio acquisition unit records the resident's voice during conversations with other residents. The audio analysis unit converts this to text and analyzes voice tone and pitch to quantify emotions. For example, if a resident speaks in a calm voice, the system can quantify that emotion as "calmness."

The Emotion Integration Evaluation Unit integrates this data to assess the resident's emotional state. For example, if a resident remains in a relaxed state, the system suggests an environment to maintain that state. The Facilitation Control Unit proposes appropriate care methods to nursing staff based on the evaluation results. For instance, if a resident is relaxed, it can instruct staff to provide a quiet environment to sustain that state.

In the step utilizing generative AI, prompts such as "Please teach me how to analyze residents' facial expressions and voices within a care facility, quantify their emotions, and propose appropriate care methods" or "Please propose an algorithm to integrate resident emotional data and adjust care progress in real time." This establishes the foundation for the AI to perform appropriate analysis and control.

In this way, the system can grasp residents' emotional states in real time within the care facility and provide care tailored to individual needs. This improves residents' quality of life and reduces the burden on care staff.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. Data generation model 58 receives input prompts containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

FIG. 3 shows an example configuration of a data processing system 210 according to a second embodiment.

As shown in FIG. 3, the data processing system 210 comprises a data processing device 12 and smart glasses 214. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

Smart glasses 214 are equipped with a computer 36, a microphone 238, a speaker 240, a camera 42, and a communication I/F 44. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions and the like. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

FIG. 4 shows an example of key functions of the data processing device 12 and the smart glasses 214. As shown in FIG. 4, specific processing is performed by the processor 28 in the data processing device 12. The specific processing program 56 is stored in the storage 32.

The specific processing program 56 is an example of a "program" related to the technology of this disclosure. Processor 28 reads the specific processing program 56 from storage 32 and executes the read specific processing program 56 on RAM 30. The specific processing is realized by processor 28 operating as specific processing unit 290 according to the specific processing program 56 executed on RAM 30.

Storage 32 stores the data generation model 58 and the emotion identification model 59. The data generation model 58 and emotion identification model 59 are used by the specific processing unit 290. The specific processing unit 290 can estimate the user's emotion using the emotion identification model 59 and perform specific processing using the user's emotion. The emotion estimation function (emotion identification function) using the emotion identification model 59 performs various estimations and predictions regarding the user's emotion, including estimating and predicting the user's emotion, but is not limited to such examples. Furthermore, emotion estimation and prediction include, for example, emotion analysis(parsing).

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is performed by the processor 46 acting as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the identification processing performed by the identification processing unit 290 of the data processing device 12 is described. The components of the system described below are implemented by the data processing device 12 and the smart glasses 214. In the following description, the data processing device 12 is referred to as the "server," and the smart glasses 214 are referred to as the "terminal."

Example 1

The flow of the specific processing is the same as that described in Example 1 of the first embodiment, so the explanation is omitted.

Application Example 1

The flow of the specific processing in Example 1 described in the above first embodiment is the same, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 may include, for example, text generation AI, image generation AI, multimodal generation AI, etc. Here, inference refers to, for example, analysis, classification, prediction, and/or summarization. The specific processing unit 290 performs the specific processing described above using the data generation model 58. The data generation model 58 may be a fine-tuned model capable of outputting inference results from prompts that do not contain instructions. In this case, the data generation model 58 can output inference results from prompts that do not contain instructions. The data processing device 12, etc., may include multiple types of data generation models 58. The data generation model 58 may include AI other than generative AI, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart glasses 214.

### Third Embodiment

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

Data processing device 12 includes a computer 22, a database 24, and a communication I/F 26. Computer 22 is an example of a "computer" related to the technology of this disclosure. Computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is include a WAN (Wide Area Network) and/or a LAN (Local Area Network).

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

Example 1

The flow of the specific processing is the same as that described in Example 1 of the first embodiment, so the description is omitted.

Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI(Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned parts is performed by AI, that processing is performed in part or in whole by AI, but is not limited to this example. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12. However, the technology disclosed herein is not limited to this, and specific processing may also be performed by the headset-type terminal 314.

### Fourth Embodiment

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 is WAN (Wide Area Network) and/or LAN (Local Area Network) are examples.

Robot 414 includes a computer 36, a microphone 238, a speaker 240, a camera 42, a communication I/F 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions and the like. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are implemented by the data processing device 12 and the robot 414. In the following description, the data processing device 12 is referred to as the "server," and the robot 414 is referred to as the "terminal."

Example 1

The flow of the specific processing is the same as that described in Example 1 of the first embodiment, so the description is omitted.

Application Example 1

The flow of the specific processing in Example 1 described in the first embodiment is the same as above, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the user input acquired by the microphone 238 to the data processing device 12. The data processing device 12 acquires the audio data from the specific processing unit 290.

Data Generation Model 58 is a so-called generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged in concentric circles radiating from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Furthermore, the upper part of the concentric circle contains "pleasant" emotions, while the lower part contains "unpleasant" emotions. Thus, the Emotion Map 400 maps multiple emotions based on the structure of their origin, with emotions that tend to occur simultaneously mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of the emotion map 400 represents the mind, while the outer part represents behavior. Therefore, the further out on the emotion map 400, the more visible the emotion becomes (manifests in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. The emotion map is, for example, Dr. Mitsuyoshi's Emotion Map (Based on research on speech emotion recognition and brain physiological signal analysis systems for emotions, Tokushima University, Doctoral Dissertation: https://ci.nii.ac.jp/naid/500000375379). The left half of the emotion map displays emotions belonging to the "Reaction" domain, where sensory aspects predominate. The right half of the emotion map displays emotions belonging to the "Situation" domain, where situational awareness is dominant.

The emotion map defines two emotions that promote learning. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in Emotion Map 900 in FIG. 10, have similar values. FIG. 10 illustrates an example where multiple emotions, such as "reassurance," "tranquility," and "encouragement," have similar emotion values.

The above description primarily explains the system of the present disclosure in terms of the functions of the data processing device 12. However, the system of the present disclosure is not necessarily implemented on a server. The system of the present disclosure may be implemented as a general information processing system. For example, the present disclosure may be implemented as a software program operating on a personal computer or as an application operating on a smartphone, etc. The method of the present disclosure may be provided to users in a SaaS (Software as a Service) format.

The above embodiment illustrated an example configuration where specific processing is performed by a single computer 22. However, the technology of this disclosure is not limited thereto. Distributed processing may be performed by multiple computers, including computer 22, for specific processing. For example, data generation model 58 may be provided on an external device of data processing device 12, and said external device may generate data corresponding to input data. For example, the data generation model 58 may be provided in an external device of the data processing device 12, and data generation corresponding to input data may be performed in said external device.

The above embodiment described a configuration where the specific processing program 56 is stored in the storage 32. However, the technology disclosed herein is not limited to this. For example, the specific processing program 56 may be stored on a portable, computer-readable non-volatile storage medium, such as a USB (Universal Serial Bus) memory. The specific processing program 56 stored on the non-volatile storage medium is installed on the computer 22 of the data processing device 12. The processor 28 executes specific processing according to the specific processing program 56.

Alternatively, the specific processing program 56 may be stored on a storage device, such as a server, connected to the data processing device 12 via the network 54. Upon request from the data processing device 12, the specific processing program 56 is downloaded and installed on the computer 22.

It should be noted that it is not necessary to store the entire specific processing program 56 in a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by a combination of one or more CPUs and software, with this processor functioning as the hardware resource executing the specific processing. Second, there is a form using a processor that implements the entire system's functionality, including multiple hardware resources executing specific processing, on a single IC chip, as exemplified by a System-on-a-chip (SoC). Thus, specific processing is implemented as a hardware resource using one or more of the various processors described above.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects of the portion pertaining to the technology of the present disclosure. Therefore, it goes without saying that within the scope not deviating from the spirit of the technology of the present disclosure, unnecessary portions may be omitted, new elements may be added, or replacements may be made to the above-described content and illustrated content. Furthermore, to avoid complexity and facilitate understanding of the technical aspects of the present disclosure, descriptions of common technical knowledge and the like that are not particularly necessary for enabling the present disclosure have been omitted from the above descriptions and illustrations.

All references, patent applications, and technical specifications cited herein are incorporated by reference to the same extent as if each reference, patent application, and technical specification were specifically and individually cited herein.

The following further details are disclosed regarding the above embodiments.

### Supplementary Note 1

A system comprising an image acquisition unit, an audio acquisition unit, an expression analysis unit, an audio analysis unit, an emotion integration evaluation unit, and a facilitation control unit. The image acquisition unit acquires real-time image data of residents using cameras installed within the care facility, capturing detailed expressions of the residents. The audio acquisition unit records residents' speech using microphones within the facility, generating audio data. The facial expression analysis unit receives video data transmitted from the video acquisition unit, detects facial feature points using face recognition technology, analyzes subtle changes in residents' facial expressions, and quantifies emotions. The voice analysis unit receives voice data transmitted from the voice acquisition unit, converts the spoken content into text using voice recognition technology, and analyzes voice tone, pitch, and speed to infer the speaker's emotional state. The emotion integration evaluation unit integrates the emotion data obtained from the expression analysis unit and the voice analysis unit to evaluate the resident's emotional state. The facilitation control unit proposes appropriate care methods to nursing staff based on the evaluation results from the emotion integration evaluation unit.

The system described in Supplementary Note 1, wherein the Facilitation Control Unit has the function of instructing care staff to provide verbal encouragement or a relaxing environment based on the resident's emotional state. When the resident feels anxious, it can propose specific countermeasures to the staff and when the resident is calm, it can propose care methods to maintain that state.

The system described in Supplementary Note 1, wherein the emotion integration evaluation unit has the function of tracking resident emotion data over time and monitoring emotional changes in real time. This enables rapid detection of changes in a resident's emotional state and prompts immediate action by care staff. For example, if a resident suddenly shows signs of anxiety, an alert can be issued to enable swift implementation of countermeasures.

### EXPLANATION OF SYMBOLS

10, 210, 310, 410 Data Processing System

12 Data Processing Device

14 Smart Device

214 Smart Glasses

314 Headset-type terminal

414 Robot

What is claimed is:

1. A data processing system for controlling progress of an interactive session among a plurality of participants, the system comprising:
a data processing device including:
a processor,
a RAM,
a non-volatile storage storing a specific processing program, an emotion identification model, and a data generation model, and
a communication interface connected to a network; and
a plurality of terminal devices each including:
a camera configured to capture image data of a participant,
a microphone configured to capture audio data of the participant,
a processor, and
a communication interface,
wherein execution of the specific processing program by the processor of the data processing device causes the processor to:
receive, from the plurality of terminal devices via the network, real-time video data and audio data corresponding to respective participants;
detect, from the video data, facial feature points including at least eye position, eyebrow movement, and mouth shape using a facial recognition algorithm;
extract, from the audio data, acoustic parameters including pitch, speech rate, and intensity;
input the detected facial feature points and extracted acoustic parameters into the emotion identification model, the emotion identification model comprising a trained neural network configured to output multidimensional emotion values corresponding to coordinates within a predefined emotion map;
integrate the multidimensional emotion values for the plurality of participants to generate a session-level aggregated emotion vector; and
determine, based on the aggregated emotion vector, control instructions that modify operation of the interactive session and transmit the control instructions to at least one of the terminal devices.

2. The system of claim 1, wherein the predefined emotion map comprises a concentric structure in which primitive emotions are positioned nearer a center and behavior-manifested emotions are positioned further from the center.

3. The system of claim 1, wherein integrating the multidimensional emotion values includes temporally weighting individual participant emotion values according to recency and speaking duration.

4. The system of claim 1, wherein the control instructions include a speaking-time redistribution signal generated when a speaking-duration imbalance exceeds a predetermined threshold.

5. The system of claim 1, wherein the control instructions include an instruction that dynamically modifies an agenda of the interactive session in response to aggregated emotion values corresponding to dissatisfaction or anxiety exceeding a threshold.

6. The system of claim 1, wherein the control instructions include a signal for controlling a physical device including at least one of:
a display device,
a speaker,
a light-emitting element, or
a motor configured to alter posture or gesture of a robot.

7. A computer-implemented method executed by a data processing device connected via a network to a plurality of terminal devices, the method comprising:
acquiring, from the plurality of terminal devices, real-time image data captured by cameras and real-time audio data captured by microphones;
detecting facial feature points from the image data using a facial recognition process;
converting spoken audio into text using a speech recognition process and extracting acoustic features including pitch variation and speech tempo;
generating participant-specific emotion vectors by inputting the facial feature points and acoustic features into a trained neural network configured to output emotion values mapped within a multidimensional emotion map;
computing a session-level emotion state by aggregating the participant-specific emotion vectors; and
automatically modifying at least one operational parameter of an electronic communication platform based on the session-level emotion state.

8. The method of claim 7, wherein automatically modifying the operational parameter includes reordering agenda items in response to sustained negative-valence emotion values.

9. The method of claim 7, wherein computing the session-level emotion state includes detecting a rate of change of emotion values over time and generating an alert when the rate of change exceeds a threshold.

10. The method of claim 7, further comprising generating, using a generative artificial intelligence model stored in the data processing device, a natural-language facilitation message conditioned on the session-level emotion state.

11. The method of claim 7, wherein the multidimensional emotion map distinguishes between reaction-domain emotions and situation-domain emotions.

12. The method of claim 7, wherein automatically modifying the operational parameter includes transmitting a control signal to a robot to alter a physical gesture or LED-based facial expression.

13. A non-transitory computer-readable storage medium storing instructions that, when executed by one or more processors of a data processing device, cause the one or more processors to:
receive multimodal participant data including video data and audio data from a plurality of terminal devices;
generate facial-expression feature vectors and acoustic feature vectors from the multimodal participant data;
determine multidimensional emotion values corresponding to coordinates within a predefined emotion map using a trained neural network;
integrate the multidimensional emotion values across the plurality of participants to determine a collective emotional condition; and
output control data configured to adjust operation of an electronic communication system based on the collective emotional condition.

14. The non-transitory computer-readable storage medium of claim 13, wherein the predefined emotion map is structured such that pleasant emotions occupy a first region and unpleasant emotions occupy a second region.

15. The non-transitory computer-readable storage medium of claim 13, wherein integrating the multidimensional emotion values includes weighting the values based on participant role metadata.

16. The non-transitory computer-readable storage medium of claim 13, wherein the control data includes an alert signal generated when aggregated anxiety-related emotion values exceed a predefined threshold.

17. The non-transitory computer-readable storage medium of claim 13, wherein the trained neural network is trained using paired training data comprising participant input data and corresponding emotion-map coordinate values.

18. The non-transitory computer-readable storage medium of claim 13, wherein adjusting operation of the electronic communication system includes modifying at least one of:
microphone activation priority,
display layout configuration,
automated summarization behavior, or
output of a facilitation template selected from stored templates corresponding to predefined session types.
